(19) United States
(12) Patent Application Publication
(10) Pub. No.: US 2020/0310047 A1
(43) Pub. Date: Oct. 1, 2020

(54) Expanded Beam Multicore Fiber Connector

(71) Applicant: Fathom Computing, Palo Alto, CA (US)

(72) Inventors: Dane R. Austin, Pacifica, CA (US); Robert T. Weverka, Boulder, CO (US); Brian A. Pesch, San Francisco, CA (US)

(21) Appl. No.: 16/831,553

(22) Filed: Mar. 26, 2020

Related U.S. Application Data
(60) Provisional application No. 62/823,819, filed on Mar. 26, 2019.

(51) Int. Cl. G02B 6/38

(52) U.S. Cl. CPC G02B 6/3885; G02B 6/3854; G02B 6/3853

(57) ABSTRACT

An expanded beam multicore fiber connector has a collimating lens attached to the end of an input multicore fiber, converting its spatially multiplexed array of micron-scale beams into an angularly multiplexed array of beams. The mating point of the connector is disposed past the input collimating lens to a point where these angularly multiplexed beams have substantial spatial overlap. The expanded beam multicore fiber connector may also have a key to aid in angular alignment. An output expanded beam multicore fiber connector mated to the first has a lens that focuses the angularly multiplexed beams onto the output multicore fiber. There is a gap between the lenses in the output and input expanded beam multicore fiber connector due to the extension of the mating point beyond the past the lens. The gap is configured to provide a substantially telecentric imaging system.

### BACKGROUND OF THE INVENTION

### Field of the Invention

The present invention relates to apparatus and methods for connecting multicore fibers. In particular, the present invention relates to expanded beam multicore fiber connectors.

### Discussion of Related Art

Multicore optical fibers are emerging as a useful technology for increasing the bandwidth of fiber optic communication links and coherent beam delivery. The beam size in these cores are typically few- or single-moded, with mode diameter of 3 um-10 um. Coupling light into these cores can be done by focusing light into each core from free space beams. Coupling light into these cores can also be done by butting two such fibers together. The transverse alignment, for low loss coupling, requires limiting the transverse displacement of the beam to a fraction of the beam size. These displacement errors are thus limited to sub-micron to a few microns. Connections between two multicore fibers that rely on butt coupling would require each of the cores maintain these alignment tolerances. Butt coupling also is susceptible to dust blocking the light in the connection.

Prior art solved some of these issues for single mode fiber with expanded beam connectors. These systems terminated a fiber by allowing the light to expand upon exiting the fiber, and collimating it again when the beam reached sufficient size. See FIG. 1 (Prior Art) Two of these systems could be mated to each other with relaxed transverse alignment tolerances, since the beams were larger. These systems are not amenable to use with multicore fibers without modification, since the beam expansion systems would deliver ray bundles off axis to the fiber end face for the cores which are off center.

FIG. 1 (prior art) shows a single mode fiber connector system consisting of a pair of mated expanded beam single mode fiber connector sides. The first expanded beam single mode fiber connector side has an input fiber 100 with a core 101. The input fiber 100 is held by a ferrule 150 which also holds a collimating lens. The ferrule has a mating surface 190 for attachment to a second expanded beam single mode fiber connector side. The second expanded beam single mode fiber connector side also has a lens ferrule and output single mode fiber 140 with core 141. The light from the fiber core 101 diffracts in an expanding cone with marginal rays 120, 121 which are collimated to the rays 130, 131 which typically propagate a minimal distance to the plane of the mating surface 190. The second expanded beam single mode fiber connector reverses the process to inject the light into the output fiber core 141.

Single-core, single-mode expanded beam connectors like the one shown in FIG. 1 have been made without regard to putting the mating surfaces extended in front of the point of collimation of the light from the core. If multicore fibers were to be attempted with this condition, only the core on the lens axis would receive a cone of light substantially normal to the fiber endface, and consequently, only this core would have low loss.

A need remains in the art for a connection system which provides low loss with multicore fibers.

### SUMMARY OF THE INVENTION

It is an objective of this invention to provide a connection system which provides low loss with multicore fibers. Such a connection system preferably is tolerant to environmental contamination.

The expanded beam multicore fiber connector of the present invention has an input side and an output side connectable at a mating surface (“input side” and “output side” are used for convenience, since light in this system can travel in either direction). The input side includes an optical element (e.g. a collimating lens) attached to the end of the input multicore fiber, converting its spatially multiplexed array of micron-scale beams (e.g. 1μ-12μ) into an angularly multiplexed array of beams of diameter 100 microns to 10 mm. The mating point of the connector is extended past the collimating lens to a point where these angularly multiplexed beams have substantial spatial overlap. The expanded beam multicore fiber connector may also have a key to aid in angular alignment. The output side of the expanded beam multicore fiber connector is mated to the input side and has an optical element that focuses the angularly multiplexed beams onto the output multicore fiber. There is a gap between the lenses in the first and second expanded beam multicore fiber connector due to the extension of the mating point beyond the past the lenses. The gap is made sufficient to provide a substantially telecentric imaging system. The telecentric imaging system improves the coupling efficiency because the light is launched normal to the multicore fiber endface.

In another embodiment, the expanded beam multicore fiber connector has an input side and an output side connectable at a mating surface. The input side includes a compound optical element (e.g. dual lens Fourier transform collimation system) attached to the end of the input multicore fiber, converting its spatially multiplexed array of micron-scale beams (e.g. 1μ-12μ) into an angularly multiplexed array of beams of diameter 100 microns to 10 mm. The compound optical element delivers angularly multiplexed beams with substantial spatial overlap close to its output. The mating point of the connector is in close proximity to the compound optical element where these angularly multiplexed beams have substantial spatial overlap. The output side of the expanded beam multicore fiber connector is mated to the input side and has a compound optical element that focuses the angularly multiplexed beams onto the output multicore fiber. The spatial overlap of the angularly multiplexed beams at the output of the compound optical element provides a substantially telecentric imaging system. The telecentric imaging system improves the coupling efficiency because the light is launched normal to the multicore fiber endface.

### BRIEF DESCRIPTION OF THE FIGURES

FIG. 1 (prior art) shows a single core fiber connector.

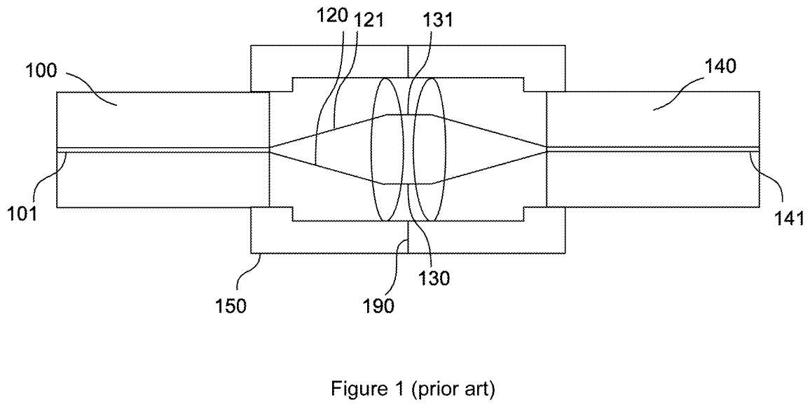

FIG. 2 shows a first embodiment of the present invention including a two-sided mated expanded beam multicore fiber connector.

FIG. 3 shows a second embodiment of the present invention including a two-sided mated expanded beam multicore fiber connector, where each side has a dual lens Fourier transform collimation system.

### DETAILED DESCRIPTION OF THE INVENTION

TABLE 1

| Ref no | Element |
|---|---|
| 100 | Input fiber |
| 101 | Core |
| 150 | Ferrule |
| 190 | Ferrule mating surface |
| 120, 121 | Marginal rays |
| 130, 131 | Collimated rays |
| 210 | Input multicore fiber |
| 211-215 | Input fiber cores |
| 220-221 | Marginal rays |
| 230 | Multicore fiber connector |
| 231 | Input side |
| 232 | Output side |
| 240 | Output multicore fiber |
| 241-245 | Output fiber cores |
| 250 | Ferrule |
| 270 | Lens |
| 271 | Lens |
| 273 | Lens |
| 274 | Lens |
| 277 | Lens |
| 278 | Lens |
| 279 | Lens |
| 290 | Ferrule mating surface |
| 330 | Multicore fiber connector |
| 331 | Input side |
| 332 | Output side |
| 240 | Output multicore fiber |

Table 1 shows elements of the invention and their associated elements.

Expanded beam fiber connectors 230, 231 according to the present invention form enlarged optical beams, generally at the mating joint 290 between the two sides 231, 232, 331, 332 of the connectors. The enlarged pencil beams at the mating point 290 have relaxed lateral position tolerance and tighter angular tolerances. Optomechanical tolerances in typical field assembled connectors are easier to achieve when the optical beams are expanded to approximately 1 millimeter in diameter. An additional advantage of expanded beam connectors 230, 330 is that each expanded beam is less susceptible to dust, since typical dust particle sizes are much smaller than the beam size.

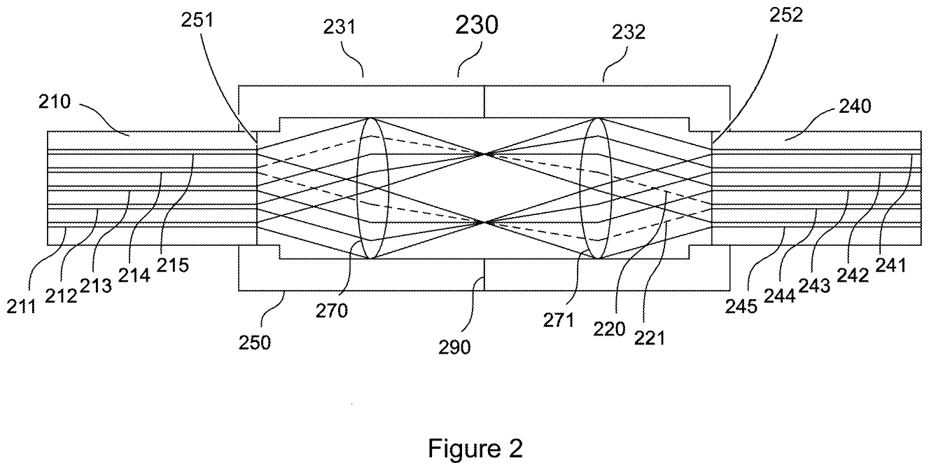

Briefly, FIG. 2 shows a first embodiment of the present invention 230 including two mated expanded beam multicore fiber connector sides 231, 232. The expanded beam multicore fiber connectors 230 of the present invention have lenses 270, 271 placed within the connectors mating two multicore fibers 210, 240 in such a way that the first multicore fiber endface 251 is imaged onto the second multicore fiber endface 252 as shown in FIG. 2. The multicore fibers may have regular arrays of cores. The regular arrays are preferably rectangular arrays or hexagonal arrays for the ease of multicore fiber manufacturing. It may be advantageous to provide a magnifying imaging system to mate two multicore fibers with different core to core spacing. It may also be desirable to make an anamorphic imaging system to couple two multicore fibers with differing core array geometries.

In a preferred embodiment, each fiber is held in a ferrule 250 that also holds one or more optical elements 270, 271, e.g. collimating lenses. A ferrule may be fabricated in various shapes and sizes and is designed to hold elements in place. The optical elements convert the diverging beams from each fiber core into a set of overlapping, angularly-multiplexed beams at the end of the ferrule. In the preferred embodiment, the end of the ferrule also serves as a mating surface to aid positional and angular alignment to a second expanded beam multicore fiber connector side. The second expanded beam multicore fiber connector side focuses the overlapping, angularly-multiplexed beams onto a telecentric array of spots for coupling into a second multicore fiber 240.

Note that terms “input” and “output” are used for convenience in describing the embodiments, but optical signals go either or both ways.

The term “free-space” refers to the fact that the light within the body is not confined in the dimensions transverse to propagation, but rather can be regarded as diffracting in these transverse dimensions.

This embodiment is an airspace implementation of a more generic class of what are referred to as free-space embodiments. In some of the other free space embodiments, the various beams are all within a body of glass.

To go into more detail, FIG. 2 shows a preferred embodiment of a multicore fiber connector 230 having two expanded beam multicore fiber connector sides 231 and 232 mated at surface 290 for coupling the input multicore fiber 210 to the output multicore fiber 240. The input multicore fiber connector side 231 has fiber 210 held by ferrule 250 which also holds lens 279 and has mating surface 290 for alignment to a second multicore fiber connector side 232. Light from the cores 211 through 215 diverge on exiting the endface 251 of the input fiber 210 and are intercepted by the lens 270 placed one focal length in front of the fiber exit endface 251. Further propagation to the plane of the mating surface 290, one focal length in front of lens 270 brings the substantially collimated beams to a point of overlap. The beams continue into the second multicore fiber connector side 232 where they separate before they are intercepted by lens 271. Lens 271 focuses the beams, directing the beams substantially normal to the facet of the multicore fiber 240, such that coupling is efficient. The normal incidence imaging, known as telecentric imaging, generally matches the acceptance angle of the cores 241-245 of the output fiber 240. The imaging is inverting in this example. One of ordinary skill in the art will note that while this figure shows a cross section with a linear array of fiber cores, the same lens system would couple a two-dimensional array of cores from fiber 210 to 240. For clarity, one of the optical paths is shown in dashed lines. Light from core 214 is coupled to core 244 inside the cone of angles bounded by the marginal rays 220 and 221 shown in dashed lines.

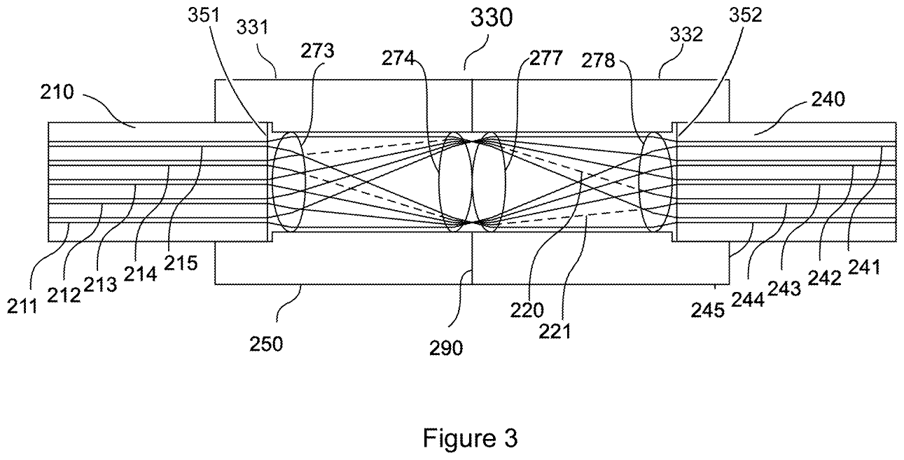

FIG. 3 shows a second embodiment 330 of the present invention including two mated expanded beam multicore fiber connector sides 331, 332 where each has a dual lens Fourier transform collimation system. The expanded beam multicore fiber connector system can be shortened and made narrower by using compound lenses with a shorter working distance. The input side connector 331 uses a first lens 273 to project the telecentric beams from a multicore fiber 210 towards a region of beam overlap approximately one focal length away. A second lens 274 collimates the beams at a position of overlap slightly in front of the second lens. FIG. 3 also shows an output side connector with a second compound lens 277, 278 which refocuses these beams onto the second multicore fiber. For lens elements with the same focal length, this system has half the length of the single-lens system of FIG. 2, and the lens apertures need only cover the extent of the cores, rather than requiring additional aperture for diffraction of the beams prior to the first lens as shown in FIG. 2.

The input multicore fiber connector 331 has fiber 210 held by ferrule 250 which also holds lenses 273 and 274 and has mating surface 290 for alignment to output multicore fiber connector 332. Light from the cores 211 through 215 diverge on exiting endface 351 of the input fiber 210 and are shortly thereafter intercepted by lens 273 placed in close proximity to endface 351. Lens 273 directs the cones of light diffracting from cores 211-215 toward the central region of lens 274. Lens 274 collimates the diffracting beams. The beams overlap a small propagation distance in front of lens 274 at the plane of mating surface 290. The beams are refocused by lens 277, converging towards endface 352 of output multicore fiber 240. Lens 278 redirects the focusing beams substantially normal to endface 352. The normal incidence imaging, known as telecentric imaging, matches the acceptance angle of the cores 241-245 of output fiber 240. The imaging is inverting in this example. One of ordinary skill in the art will note that while this figure shows a cross section with a linear array of fiber cores, the same lens system would couple a two dimensional array of cores from fiber 210 to 240. For clarity, one of the optical optical paths is shown in dashed lines. Light from core 214 is coupled to core 244 inside the cone of angles bounded by the marginal rays 220 and 221 shown in dashed lines.

Someone of ordinary skill in the art will recognize that the functions of the refractive lens may be accomplished with gradient index lenses that bend the light rays, or with diffractive or fresnel element lenses.

Embodiments of the present invention benefit from tight mechanical tolerances on the angular positioning of the two expanded beam optical interfaces. As noted above, relative roll, pitch, and yaw are ideally controlled to approximately +1-1 mrad. The concentricity (lateral alignment) and defocus (on-axis displacement) are comparatively loosely controlled tolerances. Other embodiments may require tighter tolerances, such as around 0.1 mrad.

In order to achieve these precision recommendations, the invention utilizes three major alignment considerations. The first of which involves a live (closed loop) alignment of the lens elements 273, 274, 277, 278 in each ferrule with respect to the multicore fiber 210, 240 position. This co-locates the optical axis of the optical lens to the central axis of the multicore fiber. The lens elements may then be fixed in place mechanically—with a either a retaining fastener, or by means of a suitable adhesive. The second consideration relates to fixing the fiber array to the ferrule component(s). This alignment step ensures that the roll axis of the multicore fiber is correctly keyed with regard to the ferrule's mechanical angular alignment (roll axis) features. Depending on the tolerances and features of the finished fiber, this step may be passive (a snug mechanical fit), or active (aligned in a test fixture with optical feedback, then fixed in place). The third major consideration involves careful design of the mating ferrules 250 on each side 231, 232, 331, 332 of the connector 230, 330, such that robust angular alignment can be established mechanically between the two ferrules (pitch, yaw, and roll axes)—resulting in correct alignment along the length of the optical train.

In one embodiment, the main ferrules 250 are composed of two major components: the ferrule body (male/female halves), and a strain relief element on the distal end of each connector half.

In a second embodiment, the ferrules are more complex in design and construction in order to improve upon the robustness of the interconnect in a less mechanically controlled environment (i.e. a datacenter). In this design, there are a pair of inner ferrules, a pair of outer ferrules (housings), and strain relief components. This design allows the inner ferrules to align together precisely, and rely on the outer ferrules to simply apply compressive force (by means of spring, flexure, or compressive element), pressing the inner ferrules against one another's reference surfaces. The outer ferrules are then further coupled to strain relieving elements—which attach to jacket of the fiber some distance away from the optical interconnect. These strain relief elements handle the majority of the spurious tension or moments that may be applied along the fiber connection.

The ferrule design is central to achieving good registration tolerances in the expanded beam optical connection. Given that the tolerances are tight in angular space—the ferrules should have multiple contact patches spaced a maximal distance away, in order to translate linear mechanical tolerances to angular ones. There are two main designs available to achieve registration in tip and tilt—the first calls for a radial flange pair to be extended in a perpendicular direction to the optical axis of the fiber. This results in a somewhat large and bulky design. The second embodiment to constrain tip and tilt is to extend the mechanical contact patches apart along the distance of the fiber. This results in two long (coaxial) barrels, male and female, which slide together to connect—a more slender design.

Further, to constrain roll (angular alignment, pivoting about the optical axis of the fiber), the invention allows for many possible designs. These may include precision fit pins, vee-groves, keyways, and the like. Further designs may allow for spring-loaded balls or pins to register against a flat, groove, or conical depression in the mating feature. These spring-loaded designs eliminate mechanical slop at the expense of rigidity. Nevertheless, the floating ferrule design above requires little rigidity of the inner ferrule pair, so these approaches are appealing.

Materials choice of the ferrule 250 components is also important to a successful implementation of this invention. Consideration of thermal expansion of materials is helpful to achieving an athermal design (with good performance over a wide temperature envelope). In some embodiments, ceramics (aluminum nitride, etc.) are a good choice for the inner ferrules. These materials are very rigid, can be ground to very precise tolerances, have low coefficient of thermal expansion and high thermal conductivity. In other embodiments, aluminum/stainless/or some plastics may provide suitable performance at reduced cost. The outer shell (ferrule pair) is less sensitive to material selection from a performance perspective—and may be specified in accordance with cost targets. The strain relief guards extending along the fiber may be composed of a mix of rubber and plastic.

What is claimed is:

1. Apparatus for connecting an input multicore fiber having an input-fiber endface to an output multicore fiber having an output-fiber endface where the input-fiber endface and the output-fiber endface are arranged on an optical axis, the apparatus comprising:
an output connector side including an output-fiber optical element and an output-fiber ferrule having an output-fiber ferrule mating surface, and configured to attach to the output-fiber endface;
an input connector side including an input-fiber optical element and an input-fiber ferrule having an input-fiber mating surface, and configured to attach to the input-fiber endface;
wherein the mating surfaces are configured to connect such that the optical elements are arranged along the optical axis; and
wherein the optical elements are constructed and arranged to provide telecentric imaging from the input-fiber endface to the output-fiber endface.

2. The apparatus of claim 1 wherein the output-fiber optical element is configured to columnize beams from the input fiber cores, forming expanded beams, and wherein the input-fiber optical element is configured to focus the expanded beams on the input-fiber cores substantially normal to the input-fiber endface.

3. The apparatus of claim 2 wherein the output-fiber optical element and the input-fiber optical element are each dual lens Fourier transform collimation systems.

4. The apparatus of claim 1 wherein cores in the multicore fibers are configured to generate micron-scale beams and wherein expanded beams have a diameter of about 100p to 10 mm.

5. The apparatus of claim 1 wherein the ferrules are formed of an athermal material.

6. The apparatus of claim 5 wherein the ferrules are formed of ceramic material.

7. The apparatus of claim 1 wherein the output-fiber optical element and the input-fiber optical element comprise either gradient index lenses that bend the light rays, or diffractive elements, or fresnel element lenses.

8. The apparatus of claim 1 wherein the output-fiber optical element and the input-fiber optical element have relative roll, pitch, and yaw controlled to within approximately +1-1 mrad.

9. The apparatus of claim 1 wherein the output-fiber optical element and the input-fiber optical element have relative roll, pitch, and yaw controlled to within approximately +1-0.1 mrad.

10. Optical fiber connection apparatus comprising:
a multicore fiber having an endface;
an optical element;
a ferrule connecting the endface to the optical element, the ferrule further comprising a mating surface configured to connect to a mating surface on a similar optical fiber connection apparatus;
the apparatus configured such that the optical axis of the optical element is aligned with the optical axis of the multicore fiber, and
wherein the optical element is configured to columnize expanding beams from the input fiber cores, forming expanded columnized beams at the mating surface, wherein the expanded columnized beams substantially overlap at the mating surface.

11. The apparatus of claim 10 wherein the optical element is a dual lens Fourier transform collimation system.

12. The apparatus of claim 10 wherein the optical element is affixed in place to the fiber endface mechanically.

13. The apparatus of claim 12 comprising an adhesive mechanical affixer.

14. The apparatus of claim 12 comprising retaining fastener mechanical affixer.

15. The apparatus of claim 10 further comprising a strain relief element on the mating surface.

16. The apparatus of claim 10 further comprising multiple contact patches on the mating surface.

17. The apparatus of claim 10 further comprising a radial flange extended in a perpendicular direction to the optical axis of the fiber.

18. The apparatus of claim 10 further comprising a keyed alignment mechanism.
